(19) United States
(12) Patent Application Publication
(10) Pub. No.: US 2024/0207818 A1
(43) Pub. Date: Jun. 27, 2024

(54) METHOD FOR THE REGENERATION OF SPECIAL FILTER AIDS FOR THE STABILIZATION OF BEVERAGES

(71) Applicant: BASF SE, Ludwigshafen am Rhein (DE)

(72) Inventors: Joerg KRESS, Lampertheim (DE); Beatus Daniel SCHEHL, Landau (DE)

(21) Appl. No.: 18/288,047

(22) PCT Filed: Apr. 22, 2022
(86) PCT No.: PCT/EP2022/060646

§ 371 Date: Oct. 24, 2023

(30) Foreign Application Priority Data
Apr. 28, 2021 (EP) 21170938.1

(51) Int. Cl. B01J 20/34; C08F 226/10

(52) U.S. Cl. CPC B01J 20/3425; B01J 20/3475; C08F 226/10; B01J 2220/4812

(57) ABSTRACT

The present invention relates to a method for the regeneration of special filter aids, namely, to crosslinked copolymers comprising N-vinylimidazole and N-vinylpyrrolidone as monomeric units, wherein an according copolymer is subsequently i) rinsed with water, ii) brought into contact with an aqueous solution of at least one acid, iii) rinsed with water to neutralize the copolymer, iv) brought into contact with an aqueous solution of at least one base, and v) rinsed with water or an aqueous solution of at least one acid to neutralize the copolymer. The invention also relates to a regenerated copolymer producible by said method and its use as a filter aid for the stabilization of beverages.

The present invention relates to a method for the regeneration of special filter aids, namely, to crosslinked copolymers comprising N-vinylimidazole and N-vinylpyrrolidone as monomeric units as well as to a regenerated copolymer producible by said method and its use as a filter aid for the stabilization of beverages.

Filter aids are additives that are used in solid-liquid separation processes in order to ensure separation of the solids by forming a porous precoat layer on the actual filter medium and/or by being incorporated into the filter cake structure while at the same time ensuring sufficient flow through the resulting filter cake.

Inorganic substances such as kieselguhr, perlite or aluminum oxides as well as synthetic polymers are used as filter aids. Which filter aids are used in detail also depends on the area of application. Crosslinked copolymers of N-vinylimidazole and N-vinylpyrrolidone are used as filter respectively stabilization aids for beverages, especially for tea and beer.

In beverages, metal ions such as aluminum and manganese as well as phenolic compounds such as catechin have a negative impact on clarity, sensory qualities and color and thereby reduce the stability of the beverages. The afore-mentioned copolymers can effectively bind both, metal ions as well as phenolic compounds, thereby reducing their concentration in the filtered beverages and improving the stability of the beverages.

For economic and environmental reasons, it is advantageous if filter aids can be regenerated. Regeneration over several filtration-regeneration cycles is particularly advantageous. However, regarding the regeneration of crosslinked copolymers of N-vinylimidazole and N-vinylpyrrolidone there is still no method available.

Thus, the problem underlying the present invention was to provide a method for the regeneration of these special filter aids.

This problem has been solved by a method for the regeneration of crosslinked copolymers comprising N-vinylimidazole and N-vinylpyrrolidone as monomeric units in which an according copolymer is subsequently
i) rinsed with water,
ii) brought into contact with an aqueous solution of at least one acid,
iii) rinsed with water to neutralize the copolymer,
iv) brought into contact with an aqueous solution of at least one base, and
v) rinsed with water or an aqueous solution of at least one acid to neutralize the copolymer.

It surprisingly turned out that the acid treatment in step ii) effectively removes metal ions like aluminum and manganese from the copolymer, while by the subsequent base treatment in step iv) phenolic compounds like catechin are removed. The copolymer's ability to bind metal ions as well as phenolic compounds is thereby restored, and the copolymer can again be used as filter aid for beverages.

Moreover, the binding ability for metal ions and phenolic compounds was not only restored but even enhanced after regeneration.

### Definitions

In the present invention, “aqueous solution” means that water makes up more than 50 wt. % of all solvents.

“Wt. %” stand for weight percent.

Except explicitly defined, “copolymer” presently stands for at least one, preferably one crosslinked copolymer comprising N-vinylimidazole and N-vinylpyrrolidone, preferably consisting of N-vinylimidazole, N-vinylpyrrolidone and, as bifunctional crosslinker, N,N′-divinylimidazolidone as monomeric units.

The copolymer to be regenerated is a crosslinked copolymer comprising N-vinylimidazole and N-vinylpyrrolidone as monomeric units preferably at a molar ratio in the range of from 5:1 to 15:1, more preferably of from 7:1 to 11:1. For instance, the method according to the present invention is suitable for the regeneration of Divergan® HM (available from BASF, Germany) having a molar ratio of N-vinylimidazole and N-vinylpyrrolidone of 9:1.

Besides the crosslinked copolymer comprising N-vinylimidazole and N-vinylpyrrolidone as monomeric units, there may be other filter aids present, in particular other polymers or copolymers, for example crosslinked polyvinylpyrrolidone like Divergan® RS (available from BASF, Germany).

In step i) of the inventive method, the copolymer is rinsed with water to remove residues of beverage, preferably with deionized water, wherein the water may be cold or hot, preferably having a temperature in the range of from 15 to 90° C.

In step ii) of the inventive method, the copolymer is brought into contact, preferably rinsed with an aqueous solution of at least one acid, preferably for 15 to 45 minutes, more preferably for 15 to 30 minutes, preferably at a temperature in the range of from 15 to 90° C.

The at least one acid is preferably selected from the group consisting of hydrochloric acid, nitric acid, citric acid and phosphoric acid, more preferably from the group consisting of nitric acid, citric acid and phosphoric acid which are less aggressive towards the copolymer than hydrochloric acid. Even more preferably, the at least one acid comprises, preferably is phosphoric acid which is remarkably less aggressive towards the copolymer than hydrochloric acid.

Preferably, the at least one acid has a concentration in the range of from 0.4 to 4.0 wt. %, more preferably of from 0.4 to 2.5 wt. % and even more preferably of from 0.6 to 1.2 wt. %. Surprisingly, it was found that a concentration of 1.0, 0.8 wt. % or even lower is sufficient for effectively regenerating the copolymer.

According to a preferred embodiment, the copolymer is rinsed with an aqueous solution of phosphoric acid having a concentration in the range of from 0.6 to 1.2 wt. % for 15 to 30 minutes at a temperature of 15 to 90° C.

In step iii) of the inventive method, the copolymer is rinsed with water, preferably with deionized water, wherein the water may be cold or hot, preferably having a temperature in the range of from 15 to 90° C.

In step iv) of the inventive method, the copolymer is brought into contact, preferably rinsed with an aqueous solution of at least one base, preferably for 15 to 45 minutes, more preferably for 15 to 30 minutes, preferably at a temperature in the range of from 15 to 90° C.

The at least one base is preferably selected from the group consisting of sodium hydroxide and potassium hydroxide. More preferably, the at least one base comprises, preferably is sodium hydroxide.

The concentration of the at least one base preferably lies in the range of from 0.5 to 4.0 wt. %, more preferably of from 0.8 to 2.5 wt. %.

According to a preferred embodiment, the copolymer is rinsed with an aqueous solution of sodium hydroxide having a concentration in the range of from 0.8 to 2.5 wt. % for 15 to 30 minutes at a temperature of 15 to 90° C.

In step v) of the inventive method, an aqueous solution of at least one acid can be used to neutralize the copolymer, wherein the at least one acid is preferably selected from the group consisting of hydrochloric acid, phosphoric acid, nitric acid, citric acid and carbonic acid, more preferably from the group consisting of phosphoric acid, nitric acid, citric acid and carbonic acid, even more preferably from the group consisting of phosphoric acid, nitric acid and carbonic acid.

The aqueous solution of at least one acid may be cold or hot, preferably having a temperature in the range of from 15 to 90° C.

The at least one acid can preferably be nitric acid having a concentration in the range of 0.2 to 0.7 wt. %, preferably of from 0.4 to 0.6 wt. %.

After having been rinsed with an aqueous solution of at least one acid in step v), the copolymer is preferably rinsed with water, more preferably with deionized water.

Alternatively, water, preferably deionized water can be used to neutralize the copolymer in step v), wherein the water may be cold or hot, preferably having a temperature in the range of from 15 to 90° C.

After neutralization in step v), the copolymer can be dried for at least 12 hours at a temperature of at least 50° C., preferably in a vacuum drying cabinet. Preferably, however, the copolymer is not dried but backwashed with water into a dosing vessel and kept as a suspension.

Moreover, the present invention refers to a regenerated crosslinked copolymer comprising N-vinylimidazole and N-vinylpyrrolidone as monomeric units producible by the inventive method as described above. As already set forth, the binding ability for metal ions and phenolic compounds of such copolymers is surprisingly enhanced after regeneration.

Further preferred features of the inventive copolymer are described above within the description of the inventive method.

Last not least, the present invention relates to the inventive copolymer as filter aid for the stabilization of beverages, especially of tea or beer.

At that, preferably, 5 to 150 g, more preferably 20 to 100 g of the inventive copolymer are used to stabilize one hectoliter (hl) of beverage, especially of tea or beer.

### EXAMPLES

### i) Preparation of Tea Simulants:

1000 mg of (+)-catechin hydrate (available from Sigma-Aldrich, USA) were given into a volumetric flask and dissolved in deionized water by means of ultrasonic. Then, 2.5 ml of a 2 mg/l aluminum chloride solution, 2.0 ml of a 2 mg/l manganese chloride solution and 2.15 ml of a 3 mol/l potassium chloride solution (all aqueous solutions) were added. Finally, deionized water was added until a total volume of 800 ml was reached. For every experimental run, freshly prepared tea simulant was used.

### ii) Adsorption of Catechin and Metal Ions by Copolymer:

Divergan® HM (available from BASF, Germany)—which is a crosslinked copolymer consisting of N-vinylimidazole and N-vinylpyrrolidone at a molar ratio of 9:1 and, as bifunctional crosslinker, N,N′-divinylimidazolidone as monomeric units—was added to the tea simulant prepared according to i) (see above) resulting in a mixture containing 100 g Divergan® HM/hl. This means 800 mg of Divergan® HM was added to 800 ml of tea simulant in the beginning and, due to certain losses of Divergan® HM, accordingly less Divergan® HM and tea simulant were used after each regeneration. The mixture was then agitated for 30 min at 20° C. by means of a magnetic stirrer followed by the removal of Divergan® HM by using a suction filter (porosity P3) and a vacuum flask.

iii) Catechin and Metal Ion Concentration in Tea Simulant:

After the treatment according to ii) (see above), the concentration of catechin in the tea simulant was determined photometrically by means of a 8452A Diode Array Spectrophotometer (available from Hewlett-Packard, USA) according to the manufacturer's manual, whereas, the concentration of aluminum and manganese ions was determined via FASS (flame atomic absorption spectroscopy).

### iv) Regeneration of Copolymer:

### a) Preparation of Phosphoric/Hydrochloric Acid/Sodium Hydroxide Solutions:

To obtain the aqueous solutions used in the regeneration experiments, an according amount of 10 wt. % aqueous solution of phosphoric or hydrochloric acid or sodium hydroxide, respectively, was added to deionized water in a beaker.

b) Treatment with Phosphoric/Hydrochloric Acid:

After the treatment according to ii) (see above), Divergan® HM was rinsed with deionized water into a volumetric flask containing 100 ml of phosphoric or hydrochloric acid solution prepared according to a) (see above). The resulting mixture was agitated for 20 minutes at a given temperature by means of a magnetic stirrer followed by the removal of Divergan® HM by using a suction filter (porosity P3) and a vacuum flask. Then, Divergan® HM was rinsed with cold, deionized water until the filtrate exhibited neutral pH (determined with indicator paper).

c) Treatment with Sodium Hydroxide:

After the treatment according to b) (see above), Divergan® HM was rinsed with deionized water into a volumetric flask containing 100 ml of sodium hydroxide solution prepared according to a) (see above). The resulting mixture was agitated for 20 minutes at a given temperature by means of a magnetic stirrer followed by the removal of Divergan® HM by using a suction filter (porosity P3) and a vacuum flask. Then, Divergan® HM was rinsed with cold, deionized water until the filtrate exhibited neutral pH (determined with indicator paper).

The regenerated Divergan® RM was transferred into a beaker and dried for 15 h at 60° C. in a vacuum drying cabinet. Then it was used again for the adsorption of catechin and metal ions in freshly prepared tea simulant according to ii) (see above).

TABLE 1

| | | Conc. | Temp. | Conc. | Temp. | | | |
|---|---|---|---|---|---|---|---|---|
| (Comp.) | | Acid | Acid | NaOH | NaOH | Adsorp. | Adsorp. | Adsorp. |
| Exam. | Acid | [wt. %] | [° C.] | [wt. %] | [° C.] | Cat. [%] | Al [%] | Mn [%] |
| CE1 | — | — | — | — | — | 30.7* | 28* | n.d.* |
| CE2 | — | — | — | — | — | 30.5* | 24* | 10* |
| E1 | H₃PO₄ | 2.0 | 85 | 2.1 | 85 | 43.6** | 33.2** | 24.4** |
| E2 | H₃PO₄ | 1.0 | 85 | 2.0 | 85 | 33.3** | 35.0** | 18.0** |
| E3 | H₃PO₄ | 1.0 | 85 | 1.0 | 85 | 42.4** | 39.3** | 20.3** |
| E4 | H₃PO₄ | 1.0 | 50 | 1.0 | 50 | 37.2** | 37.0** | 18.5** |
| E5 | H₃PO₄ | 1.0 | 20 | 1.0 | 20 | 33.7** | 36.7** | 19.0** |
| E6 | H₃PO₄ | 0.8 | 50 | 1.0 | 50 | 37.5** | 35.5** | 17.5** |
| E7 | H₃PO₄ | 0.8 | 20 | 1.0 | 20 | 34.9** | 36.3** | 20.3** |
| E8 | HCl | 1.0 | 20 | 1.0 | 20 | 36.1** | 33.3** | 16.7** |
| E9 | HCl | 1.0 | 50 | 1.0 | 50 | 34.9** | 28.0** | 18.3** |
| E10 | HCl | 1.0 | 85 | 1.0 | 85 | 32.9** | 25.3** | 15.0** |

*value with fresh unused copolymer;
**mean values over 10 regeneration cycles; (Comp.) Exam. = (Comparative Example), Conc. = Concentration, Temp. = Temperature, Adsorp. = Adsorption, n.d. = not determined

The results of the adsorption experiments with differently regenerated copolymers (inventive examples E1 to E10) as well as with fresh, non-regenerated copolymers (comparative examples CE1 and CE2) are shown in Tab. 1 above.

As one can see from comparing CE1 and CE2 with E1 to E10, the adsorption in % (1−c₁/c₀ with c₁=concentration after treatment with copolymer and c₀=concentration before treatment), i.e. the binding ability, is higher in case E1 to E10, i.e. for copolymers regenerated with the inventive method. This applies to catechin, manganese ions and, essentially, for aluminum ions as well. Moreover, the use of phosphoric acid instead of hydrochloric acid leads to a remarkably higher adsorption of aluminum ions as one can notice when comparing E3 with E10, E5 with E8 or E6 with E9, respectively.

1.-15. (canceled)

16. A method for the regeneration of crosslinked copolymers comprising N-vinylimidazole and N-vinylpyrrolidone as monomeric units wherein the copolymer is subsequently
i) rinsed with water,
ii) brought into contact with an aqueous solution of at least one acid,
iii) rinsed with water to neutralize the copolymer,
iv) brought into contact with an aqueous solution of at least one base, and
v) rinsed with water or an aqueous solution of at least one acid to neutralize the copolymer.

17. The method according to claim 16 wherein the monomeric units N-vinylimidazole and N-vinylpyrrolidone are present at a molar ratio in the range of from 5:1 to 15:1.

18. The method according to claim 16 wherein the at least one acid in step ii) is selected from the group consisting of hydrochloric acid, nitric acid, citric acid and phosphoric acid.

19. The method according to claim 19 wherein the at least one acid in step ii) comprises phosphoric acid.

20. The method according to claim 16 wherein the at least one acid in step ii) has a concentration in the range of from 0.4 to 2.5 wt. %.

21. The method according to claim 16 wherein the at least one base in step iv) is selected from the group consisting of sodium hydroxide and potassium hydroxide.

22. The method according to claim 16 wherein the at least one base in step iv) has a concentration in the range of from 0.8 to 2.5 wt. %.

23. The method according to claim 16 wherein in step v) an aqueous solution of at least one acid is used, preferably selected from the group consisting of phosphoric acid, nitric acid, citric acid and carbonic acid, more preferably from the group consisting of phosphoric acid, nitric acid and carbonic acid.

24. The method according to claim 23 wherein the at least one acid in step v) is nitric acid having a concentration in the range of from 0.2 to 0.7 wt. %.

25. The method according to claim 23 wherein the copolymer is rinsed with water after having been rinsed with the aqueous solution of at least one acid in step v).

26. The method according to claim 16 wherein in step v) water is used.

27. The method according to claim 16 wherein, after step v), the copolymer is backwashed with water into a dosing vessel and kept as a suspension.

28. A regenerated crosslinked copolymer comprising N-vinylimidazole and N-vinylpyrrolidone as monomeric units producible by the method according to claim 16.

29. A method comprising utilizing the copolymer according to claim 28 as a filter aid for the stabilization of beverages.

30. The method according to claim 29 wherein 5 to 150 g of the copolymer are used to stabilize one hectoliter of beverage.
